(19) United States
(12) Patent Application Publication
(10) Pub. No.: US 2013/0085921 A1
(43) Pub. Date: Apr. 4, 2013

(54) HOME ENERGY COLLABORATIVE MESH PLATFORM

(71) Applicants: Djung Nguyen, San Diego, CA (US); Abhishek Patil, San Diego, CA (US); Megan Marie Farrell, San Diego, CA (US)

(72) Inventors: Djung Nguyen, San Diego, CA (US); Abhishek Patil, San Diego, CA (US); Megan Marie Farrell, San Diego, CA (US)

(73) Assignee: SONY CORPORATION

(21) Appl. No.: 13/248,318

(22) Filed: Sep. 29, 2011

(51) Int. Cl. G06Q 40/04; G05B 15/02; G06Q 10/10

(52) U.S. Cl. 705/37; 700/286

(57) ABSTRACT

A method to share, barter, lend, trade, rent and give energy through technology and peer communities. An online service which allows users to globally monitor, manage and redistribute energy (electricity) at the individual house level. This method of collaborative consumption gives members in the organized communities the benefit of ownership with reduced personal burden and costs. The fundamental value is that it provides an alternative to traditional forms of purchasing and ownership.

### FIELD OF THE INVENTION

The present application relates generally to sharing energy among households using an online service.

### BACKGROUND OF THE INVENTION

Energy may be one of the most pressing issues of modernity, and specifically, the need to wisely use energy both from an environmental and resource conservation standpoint. To this end, energy consumption paradigms have been proposed and in some cases implemented in which, for instance, the cost of electricity to the end user varies to reflect high usage and low usage periods. As understood herein, such top-down models, while not entirely ineffective, fail to provide the advantages of individual granularity that many thousands or even millions of individuals can achieve when connected together and collaboratively allocating energy.

### SUMMARY OF THE INVENTION

A home energy collaborative mesh platform allows users to manage, monitor, and redistribute energy from low usage areas to high usage area. The platform may be embodied as a social networking community focusing specifically on energy monitoring, consumption and redistribution. For example, a person living in a cooler climate could redistribute (trade, sell, or barter) his electricity to someone living in a warmer climate during the summer months; a person on vacation could share his electricity by redistributing his electricity usage at his vacation home, thus reducing the costs of his vacation rental.

Accordingly, a system includes a processor, an energy meter communicating signals to the processor representing energy use of an establishment, and a display. Computer readable storage media bear instructions executable by the processor to report energy use as indicated by the energy monitor to a server, and to present on the display a user interface (UI) informing an occupant of the establishment of energy sharing opportunities with other establishments.

In some embodiments, the server is a social networking server and the establishments in the system are “friended” to the server so that the server notifies establishments of energy sharing opportunities using “friending” messages.

If desired, energy sharing messages are sent between establishments and individual user energy accounts are altered according to energy sharing between establishments. In example implementations a processor in the system determines that an energy account of a first establishment in the system is overdrawn and responsive thereto alerts the first establishment that it is overdrawn. The determination that an energy account is overdrawn can be undertaken by comparing an energy usage for a predetermined length of time as indicated by an energy monitor with an allocated energy usage threshold. Or, the determination that an energy account is overdrawn can be undertaken by comparing an energy usage for a predetermined date and time period as indicated by an energy monitor with an allocated energy usage threshold.

Also, a processor in the system can determine that an energy account of a first establishment in the system is underdrawn and responsive thereto alerts the first establishment that it is underdrawn. Responsive to a determination that the energy account is underdrawn, a processor in the system may present on a display of the establishment corresponding to the underdrawn energy account a list of options including one or more of: receive remuneration for saved energy, bank the credits for saved energy in an account, receive a fraction of a value of saved energy in remuneration and bank an indication of a remainder of saved energy in an account, and dedicate saved energy to the public remuneration-free.

In another aspect, a system includes a processor associated with an energy-consuming establishment and a display communicating with the processor. Computer readable storage media bear instructions executable by the processor to present on the display a first user interface (UI) notifying a user that, based on information from an energy monitor, the user has excess energy and giving the user an option selectable by means of the UI to barter energy with another user.

If desired, responsive to selecting to barter energy the processor presents on the display an identification of a candidate barter neighbor as requiring additional energy. Responsive to selection to barter with the candidate barter neighbor a message may be sent from the establishment to the candidate barter neighbor that the user wishes to barter. The user can be given an option to designate which types of establishments it wishes to share energy with.

In example embodiments the processor presents on the display a UI enabling the user to accept or decline an offer of additional energy from another establishment. Responsive to the establishment bartering energy with the candidate barter neighbor, an account of the establishment can be credited with a first number of energy unit credits and an account of the candidate barter neighbor debited a second number of energy unit credits. The first number can equal the second number or the numbers may not be equal, in which case an energy difference is established between the first and second numbers. The energy difference can be returned to the community at large and a value of the energy difference credited to an operator of a management server coordinating barter between the establishment and the candidate barter neighbor.

Also, if desired the processor, responsive to a determination that the establishment is overdrawn on its energy allocation by more than a higher threshold amount notifies the user that a maximum energy usage has been exceeded, giving the user selections to be billed immediately, or to transfer future allocated energy units elsewhere, limiting a future amount of energy supplied to the establishment until the energy account of the establishment is brought back into balance.

In still additional embodiments the processor, responsive to a determination that the establishment is underdrawn on its energy allocation by less than a lower threshold amount, notifies the user that the establishment has earned extra energy credits. The processor presents on the display a list of options for disposing of the earned extra energy credits, with the list including receive remuneration for saved energy, bank the credits for saved energy in an account, receive a fraction of a value of saved energy in remuneration and bank an indication of a remainder of saved energy in an account, and dedicate saved energy to the public remuneration-free.

Present principles apply to local bartering and individual producers, for example, those who have solar panels and can generate excess energy. The transfer of energy can be local or within a local neighborhood (same power company/power grid). An example would be an individual producer who is generating excess power. He could contribute it towards the heating of the community pool or powering the street light and in returning reducing the overall HOA bills.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of example logic in accordance with present principles;

FIG. 3 is an example screen shot of a first user interface (UI) for a supplying home;

FIG. 4 is an example screen shot of a first user interface (UI) for a receiving home;

FIG. 5 is an example screen shot of a second user interface (UI) for the supplying home;

FIG. 6 is an example screen shot of a second user interface (UI) for the receiving home; and

FIG. 7 is an example screen shot of a third user interface (UI) for the supplying home.

### DETAILED DESCRIPTION OF THE PREFERRED EMBODIMENT

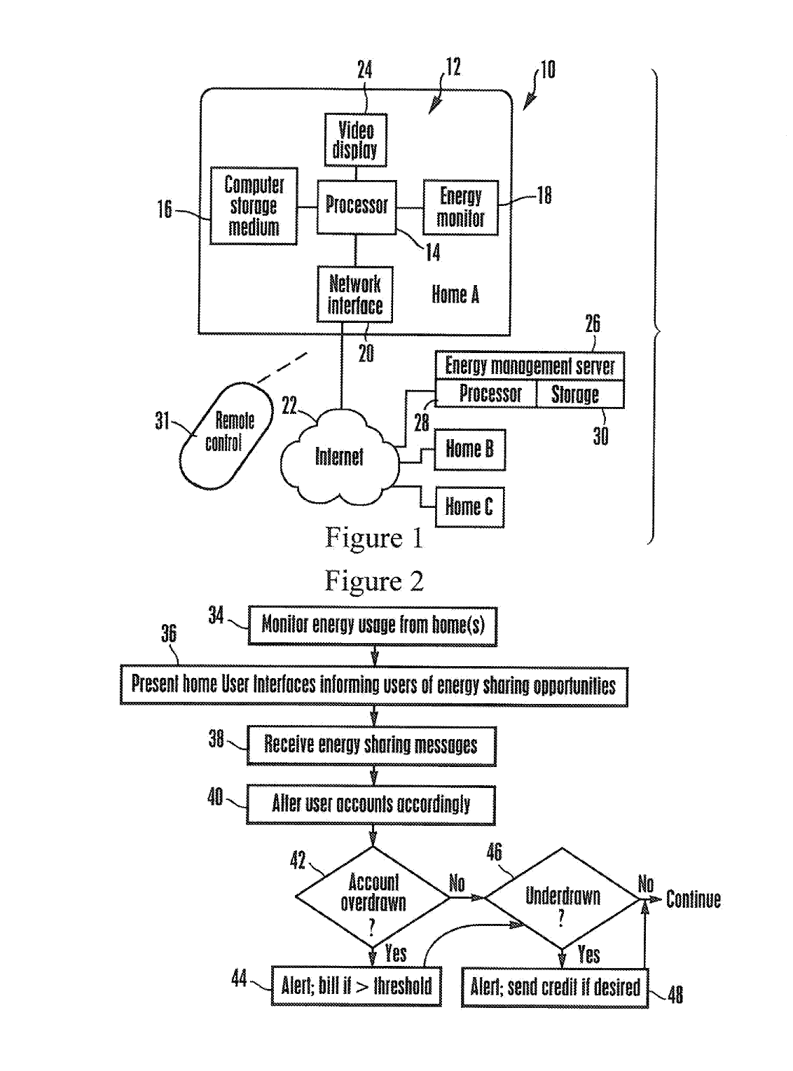

Referring initially to the non-limiting example embodiment shown in FIG. 1, a system 10 includes a home energy monitoring device 12 such as a computer or an audio video display device (AVDD) such as a TV which in turn includes a processor 14 accessing a tangible computer readable storage medium 16 such as disk-based or solid state storage. One or more energy monitors 18 may communicate with the processor 14. The energy monitor 18 may be a home energy meter such as an ammeter or other energy usage monitor. The device 12 is typically associated with a first building or dwelling or private residence (labeled “home A” in FIG. 1) and can communicate with other buildings or dwellings or private residences (labeled homes “B” and “C” in FIG. 1 for convenience only and without loss of generality) through a network interface 20 such as a wired or wireless modem (in some cases in concert with a wireless access point such as a wireless in-home router) communicating with the Internet 22. It is to be understood that while only three homes are shown in FIG. 1, present principles apply to collaboration between many more homes, each having a device similar to the device 12.

The below-described screen shots of example user interfaces may be presented on a video display 24 of the device 12 which is controlled by the processor 14. If desired, management of the collaborative energy-sharing network described herein may be promoted by an energy management server 26 having one or more processors 28 accessing one or more computer readable storage media 30. Selections from the UIs may be made by an input device such as but not limited a wireless remote control (RC) 31, a computer mouse or keyboard, touch display, etc.

Now referring to FIG. 2 for an understanding of example logic that may be employed according to present principles, two or more of the homes in FIG. 1 monitor their energy usage as indicated by their respective energy monitors 18. Each home may report its energy usage via its respective processor 14 and respective network interface 20 to the server 26.

At block 36, one or more of the below-described UIs are presented on the displays 24 of the home devices 12 informing the respective occupants of energy sharing opportunities with other individual homes. The UIs may be sent to the homes from the server 26 through the Internet or the homes may communicate peer to peer to understand what energy sharing opportunities exist in the mesh. Note that the server 26 may be a social networking server and the homes in the system may be “friended” to the server 26 so that the server 26 can notify homes, using, e.g., the UIs described below, of energy sharing opportunities using “friending” messages.

Proceeding to block 38, energy sharing messages are sent between homes using the UIs presented at block 36 and at block 40, individual user energy accounts are altered according to the sharing undertaken at block 38. Again, these energy sharing messages may be undertaken using a social networking system in which case the server 26 can be a social networking server.

Proceeding to decision diamond 42, it is determined by, e.g., the server 26 whether any individual account is overdrawn on its allocated energy usage, e.g., whether the energy usage for a predetermined length of time or predetermined date and time period exceeds a threshold usage. This determination may be made for all user accounts in the system periodically. In the case of an overdrawn account, for that account the logic moves to block 44 to alert the overdrawn user by, e.g., presenting the appropriate UI described below on the associated display 24 via the Internet 22. Enhanced charges for exceeding the usage threshold may be billed to the user at block 44 also.

On the other hand, the logic may continue from decision diamond 42 to decision diamond 46 to determine for each of the accounts in the system whether any individual account is underdrawn. If so, the energy-efficient user may be given a congratulatory alert at block 48 using the appropriate UI described below and the user's account may be credited with funds if desired. The alert may originate at the server 26 and be transmitted through the Internet 22 to be presented on the associated display 24 of the energy efficient user. The logic may then loop back to continue at, e.g., block 34.

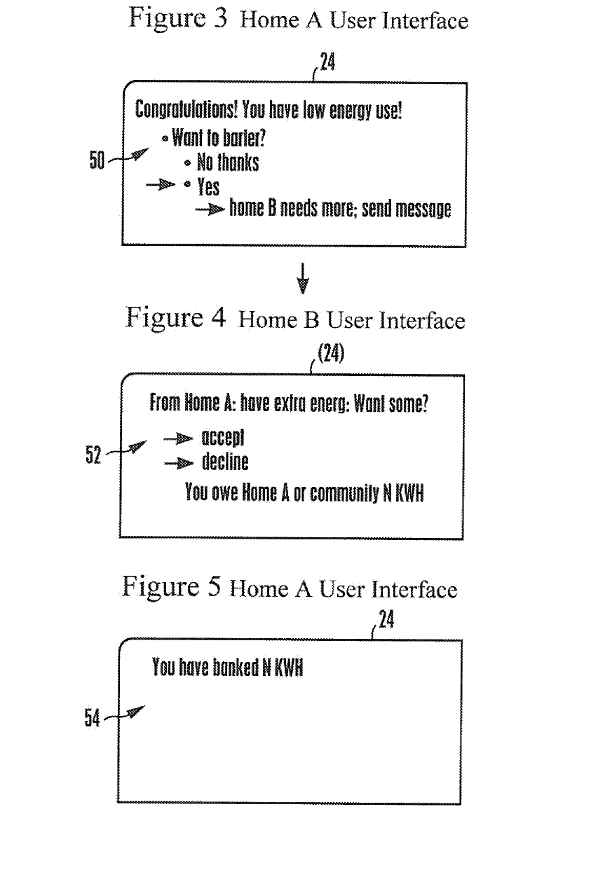

FIGS. 3-7 show example UIs in accordance with principles above that may be presented on the displays 24 of the homes in the system. For illustration, assume that home “A” is an energy efficient supplying home and home “B” is a receiving home requiring additional energy. Accordingly, the UI 50 of FIG. 3 may be presented on, e.g., the display 24 of home “A” at block 36 in FIG. 2, notifying the user that, based on the information from the energy monitor 18, the user has excess energy and giving the user the opportunity to barter, e.g., “yes, barter” and “no thanks”. Assume the user has selected “yes, barter”; the server 26 (or in a peer to peer network, home “B”) responds by identifying home “B” as requiring additional energy and prompting the user in home “A” to select home “B” as a recipient, in which case a message is sent from home “A” upon selection that it wishes to barter with home “B”. Note that while only home “B” is listed in FIG. 3, multiple homes, e.g., the ten closest homes to home “A” that require additional energy, may be listed. Note further that the user of home “A” may be given a setup menu to designate which types of homes it wishes to share energy with, e.g., vacation homes, homes in tropical climes, summer mountain homes, etc.

FIG. 4 illustrates a UI 52 that can be presented on the display of home “B” responsive to the user of home “A” selecting to share energy with home “B” via the UI 50 of FIG. 3. As shown, the user is enabled to accept or decline the offer from home “A” to send home “B” additional energy. A message 53 indicates that acceptance will mean the home “B” user owes the home “A” user or the community as a whole, in some embodiments, “N” kilowatts, wherein N is the number of energy units (e.g., kilowatt-hours) provided to the home “B” account from the home “A” account or some fraction or multiple thereof. Acceptance of the offer by the home “B” user results in the user of home “A” being notified of such by the UI 54 of FIG. 5. Note that the amount of energy units credited to home “A” may not match the amount of energy units accounted against home “B”, with the energy difference being returned to the community at large and the value of the energy difference being credited to the operator of the management server 26.

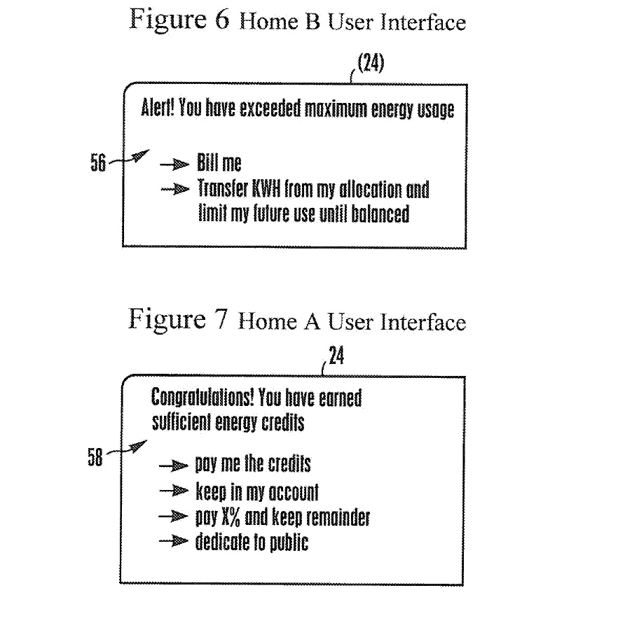

Recall from FIG. 2 that monitoring may indicate that a particular home is overdrawn on its energy allocation by more than a higher threshold amount or underdrawn by less than a lower threshold amount. With this in mind, a UI 56 (FIG. 6) may be presented on the display 24 of an overdrawn home while a UI 58 (FIG. 7) may be presented on the display 24 of an underdrawn home. As shown, the UI of FIG. 6 notifies the user that the maximum energy usage as allocated by, e.g., a utility or government regulatory agency has been exceeded, giving the user selections to be billed immediately, or to transfer future energy units allocated to the overdrawn home elsewhere, limiting the future amount of energy supplied to the overdrawn home until the energy account of the home is brought back into balance (e.g., below the upper threshold).

On the other hand, the UI 58 of FIG. 7 congratulates the user on being energy efficient and notifies the user that the home has earned extra energy credits. The user may elect to receive remuneration for the extra credits, or bank the credits in the energy account of the underdrawn home for future use. In the latter case, one way to reflect the banked credits is to raise the underdrawn home's maximum threshold by an amount equal to the banked credits.

Yet again, if desired the user may be given the option of receiving a fraction of the value of the extra energy credits in remuneration and bank the remainder (essentially, a combination of the first two options discussed above) or release the remainder to the public. Again still, as shown the user may be given the option of dedicating the saved energy to the public, maintaining the current maximum threshold of the underdrawn account in an act of altruism.

While the particular HOME ENERGY COLLABORATIVE MESH PLATFORM is herein shown and described in detail, it is to be understood that the subject matter which is encompassed by the present invention is limited only by the claims.

What is claimed is:

1. System comprising:
processor;
energy meter communicating signals to the processor representing energy use of an establishment;
display;
computer readable storage medium bearing instructions executable by the processor to:
report energy use as indicated by the energy monitor to a server; and
present on the display a user interface (UI) informing an occupant of the establishment of energy sharing opportunities with other establishments.

2. The system of claim 1, wherein the server is a social networking server and the establishments in the system are “friended” to the server so that the server notifies establishments of energy sharing opportunities using “friending” messages.

3. The system of claim 1, wherein energy sharing messages are sent between establishments and individual user energy accounts are altered according to energy sharing between establishments.

4. The system of claim 1, wherein at least one processor in the system determines that an energy account of a first establishment in the system is overdrawn and responsive thereto alerts the first establishment that it is overdrawn.

5. The system of claim 4, wherein the determination that an energy account is overdrawn is undertaken by comparing an energy usage for a predetermined length of time as indicated by an energy monitor with an allocated energy usage threshold.

6. The system of claim 4, wherein the determination that an energy account is overdrawn is undertaken by comparing an energy usage for a predetermined date and time period as indicated by an energy monitor with an allocated energy usage threshold.

7. The system of claim 1, wherein at least one processor in the system determines that an energy account of a first establishment in the system is underdrawn and responsive thereto alerts the first establishment that it is underdrawn.

8. The system of claim 7, wherein responsive to a determination that the energy account is underdrawn, a processor in the system presents on a display of the establishment corresponding to the underdrawn energy account a list of options including one or more of: receive remuneration for saved energy, bank the credits for saved energy in an account, receive a fraction of a value of saved energy in remuneration and bank an indication of a remainder of saved energy in an account, and dedicate saved energy to the public remuneration-free.

9. System comprising:
processor associated with an energy-consuming establishment;
display communicating with the processor; and
computer readable storage medium bearing instructions executable by the processor to:
present on the display a first user interface (UI) notifying a user that, based on information from an energy monitor, the user has excess energy and giving the user an option selectable by means of the UI to barter energy with another user.

10. The system of claim 9, wherein responsive to selecting to barter energy the processor presents on the display an identification of a candidate barter neighbor as requiring additional energy.

11. The system of claim 10, wherein responsive to selection to barter with the candidate barter neighbor a message is sent from the establishment to the candidate barter neighbor that the user wishes to barter.

12. The system of claim 9, wherein the user is given an option to designate which types of establishments it wishes to share energy with.

13. The system of claim 9, wherein the processor presents on the display a UI enabling the user to accept or decline an offer of additional energy from another establishment.

14. The system of claim 9, wherein responsive to the establishment bartering energy with the candidate barter neighbor; an account of the establishment is credited with a first number of energy unit credits and an account of the candidate barter neighbor is debited a second number of energy unit credits.

15. The system of claim 14, wherein the first number equals the second number.

16. The system of claim 14, wherein the first number does not equal the second number such that an energy difference is established between the first and second numbers.

17. The system of claim 16, wherein the energy difference is returned to the community at large and a value of the energy difference is credited to an operator of a management server coordinating barter between the establishment and the candidate barter neighbor.

18. The system of claim 9, wherein the processor, responsive to a determination that the establishment is overdrawn on its energy allocation by more than a higher threshold amount notifies the user that a maximum energy usage has been exceeded, giving the user selections to be billed immediately, or to transfer future allocated energy units elsewhere, limiting a future amount of energy supplied to the establishment until the energy account of the establishment is brought back into balance.

19. The system of claim 9, wherein the processor, responsive to a determination that the establishment is underdrawn on its energy allocation by less than a lower threshold amount, notifies the user that the establishment has earned extra energy credits.

20. The system of claim 19, wherein the processor presents on the display a list of options for disposing of the earned extra energy credits, the list including receive remuneration for saved energy, bank the credits for saved energy in an account, receive a fraction of a value of saved energy in remuneration and bank an indication of a remainder of saved energy in an account, and dedicate saved energy to the public remuneration-free.
